(19) United States
(12) Patent Application Publication
(10) Pub. No.: US 2007/0183699 A1
(43) Pub. Date: Aug. 9, 2007

(54) Bearing unit and motor using the bearing unit

(75) Inventor: Yuji Shishido, Kanagawa (JP)

Correspondence Address: RADER FISHMAN & GRAUER PLLC, LION BUILDING, 1233 20TH STREET N.W., SUITE 501, WASHINGTON, DC, 20036, US

(73) Assignee: Sony Corporation, Tokyo (JP)

(21) Appl. No.: 11/698,869

(22) Filed: Jan. 29, 2007

(30) Foreign Application Priority Data
Feb. 8, 2006 (JP) 2006-031505

(51) Int. Cl. F16C 32/06

(52) U.S. Cl. 384/107

(57) ABSTRACT

A bearing unit includes: a radial bearing for bearing a shaft in the circumferential direction of the shaft; a first housing member provided on the outer periphery side and on one end side in the axial direction of the radial bearing and operative to hold the radial bearing; and a second housing member provided on the outer periphery side of the first housing member and on the other end side in the axial direction of the radial bearing, wherein the first and second housing members are united by a screw part provided on the outer periphery side of the first housing member and a screw part provided on the inner periphery side of the second housing, so as to sealingly contain the radial bearing, with a shaft passage hole provided on one end side or the other end side in the axial direction so as to permit the shaft to pass therethrough; and the inside of the united first and second housing members is filled with a viscous fluid.

### CROSS REFERENCES TO RELATED APPLICATIONS

The present invention contains subject matter related to Japanese Patent Application JP 2006-031505, filed in the Japanese Patent Office on Feb. 8, 2006, the entire contents of which being incorporated herein by reference.

### BACKGROUND OF THE INVENTION

1. Field of the Invention

The present invention relates to a bearing unit bearing a rotating shaft rotatably or bearing a rotating body rotatably relative to a shaft, and a motor using the bearing unit.

2. Description of the Related Art

As a bearing unit for bearing a rotating body rotatably, there has been known a unit configured as shown in FIG. 14.

The bearing unit 200 shown in FIG. 14 supports a rotating shaft 201 rotatably, and includes radial bearing means 202 such as a slide bearing for bearing the rotating shaft 201 in the circumferential direction of the rotating shaft 201, thrust bearing means 203 such as a pivot bearing formed of a polymeric material such as nylon for bearing one end in the thrust direction of the rotating shaft 201, a housing 204 formed of a metal such as brass, containing the radial bearing means 202 and the thrust bearing means 203 therein and filled with a viscous fluid such as a lubricating oil, and a seal member 205 formed of a metal such as brass in a plate-like shape for preventing leakage of the viscous fluid filling the housing 204. A fastening part between the housing 204 and the seal member 205 is sealed with a UV-curing type adhesive or the like, for preventing the lubricating oil from exuding.

In the case where an oil-impregnated sintered bearing or the like is used as the radial bearing means 202 in the bearing unit 200, it is important to retain the viscous fluid such as a lubricating oil, for maintaining a good lubricating condition for the radial bearing unit 202.

In addition, where the bearing unit 200 is used for a hard disk drive (HDD), if an out-gas or mist is generated due to exudation of the lubricating oil, a trouble such as stiction may be generated. Therefore, it is extremely important in the bearing unit 200 to prevent leakage of the lubricating oil.

In such a bearing unit 200, a sealing 206 with a UV-curing type adhesive or the like is applied to the periphery of the seal member 205, to thereby prevent exudation of the lubricating oil, as above-mentioned. As a result, metal-made expensive members may be needed as the housing 204 and the seal member 205, and a sealing step may be needed to apply the sealing 206 to the fastening part between the housing 204 and the seal member 205, leading to a troublesome assembling step and to increases in the number of component parts and in cost. (See Japanese Patent Laid-open No. 2005-69382 (refer to prior-art examples, FIGS. 23 to 26) as Patent Document

### SUMMARY OF THE INVENTION

Thus, there is a need for a bearing unit which can be made simple in configuration and small in size, the assembly process of which can be simplified, and in which leakage of a viscous fluid such as a lubricating oil can be prevented, and for a motor using the bearing unit.

According to one embodiment of the present invention, there is provided a bearing unit including: a radial bearing for bearing a shaft in the circumferential direction of the shaft; a first housing member provided on the outer periphery side and on one end side in the axial direction of the radial bearing and operative to retain the radial bearing; and a second housing member provided on the outer periphery side of the first housing member and on the other end side in the axial direction of the radial bearing, wherein the first and second housing members are united by a screw part provided on the outer periphery side of the first housing member and a screw part provided on the inner periphery side of the second housing member so as to sealingly contain the radial bearing, with a shaft passage hole provided on the one end side or the other end side in the axial direction so as to permit the shaft to pass therethrough, and the inside of the united first and second housing members is filled with a viscous fluid.

According to another embodiment of the present invention, there is provided a motor including a bearing unit bearing a rotor rotatably relative to a stator, wherein the bearing unit according to the one embodiment of the invention is used as the bearing unit in the motor.

The bearing unit and the motor using the bearing unit according to the embodiments of the present invention can be made simple in configuration and small in size, the assembly process thereof can be simplified, and the leakage of a viscous fluid such as a lubricating oil used therein can be prevented, whereby reliability thereof can be enhanced.

### BRIEF DESCRIPTION OF THE DRAWINGS

FIG. 1 is a sectional view showing the configuration of a motor according to an embodiment of the present invention;

FIG. 2 is a sectional view of a bearing unit according to an embodiment of the present invention;

FIG. 3 is an exploded perspective view of the bearing unit;

FIGS. 4A to 4C show examples of an anti-slip mechanism for a bearing holder member constituting the bearing unit, in which FIG. 4A is a perspective view of a bearing holder member having an anti-slip mechanism including an engaging part at one position, FIG. 4B is a perspective view of a bearing holder member having an anti-slip mechanism including engaging parts at two positions, and FIG. 4C is a perspective view of a bearing holder member having an anti-slip mechanism including an engaging groove;

FIG. 5 shows an example in which an anti-slip mechanism is provided for a case member constituting the bearing unit, and is a perspective view of a case member having an anti-slip mechanism including an engaging part at one position;

FIG. 6 is a sectional view showing another example of the bearing unit according to an embodiment of the present invention;

FIG. 7 is a perspective view of dynamic pressure generating grooves formed in the inner peripheral surface of a radial bearing constituting the bearing unit shown in FIG. 6;

FIGS. 8A and 8B show an example in which a communicating passage is provided in the bearing unit according to an embodiment of the present invention, in which FIG. 8A is a sectional view of the bearing unit, and FIG. 8B is a perspective view showing grooves constituting the communicating passage provided in a radial bearing of the bearing unit;

FIGS. 9A to 9D show other examples wherein a communicating passage is provided in the bearing unit, in which FIG. 9A is a sectional view of the bearing unit, FIG. 9B is a perspective view showing first grooves constituting the communicating passage provided in a bearing holder member in the bearing unit, FIG. 9C is a bottom view showing third grooves constituting the communicating passage provided in the bearing holder member, and FIG. 9D is a perspective view showing second grooves constituting a communicating passage provided in a seal member of the bearing unit;

FIG. 10 is a sectional view showing an example in which an axis adjusting means is provided in the bearing unit according to an embodiment of the present invention;

FIG. 11 is a sectional view showing a further example of the bearing unit;

FIG. 12 is a sectional view showing an example in which a case member of a bearing unit is united to a stator of a motor according to an embodiment of the present invention;

FIG. 13 is a sectional view showing an example in which a bearing holder member of a bearing unit is united to the stator of the motor; and

FIG. 14 is a sectional view showing a bearing unit used in the related art.

### DETAILED DESCRIPTION OF THE PREFERRED EMBODIMENTS

Now, some embodiments of a bearing unit and a motor using the bearing unit to which the present invention is applied will be described below referring to the drawings.

Here, a motor for use in a radiator of an electronic apparatus such as a portable type computer, which is an information processing apparatus for applying arithmetic operations or the like to various information, will be described. The radiator is provided in the inside of the portable type computer or the like. The radiator includes a metallic base, a motor 1 mounted onto the base, a fan 3 rotated by the motor 1, a fan case 4 encasing the fan 3, and a heat sink. The motor 1 for driving the fan 3 of the radiator to rotate will be described in detail below.

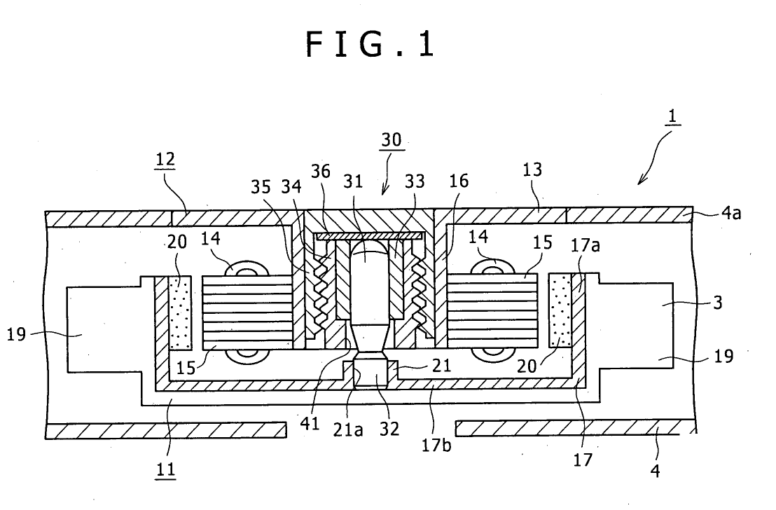

The motor 1 using a bearing unit 30 according to an embodiment of the present invention includes a rotor 11 and a stator 12, as shown in FIG. 1.

The stator 12 is provided integrally on a top plate 4a side of the fan case 4 encasing the fan 3 rotated by the motor 1 together with the motor 1. The stator 12 includes a stator yoke 13, the bearing unit 30 according to an embodiment of the present invention, a coil 14, and a core 15 around which the coil 14 is wound. The stator yoke 13 may be formed as one body with the top surface part 4a of the fan case 4, i.e., may be constituted of a part of the fan case 4, or may be formed separately from the fan case 4. The stator yoke 13 is formed, for example, of iron. The bearing unit 30 is fixed in a holder 16 formed in a tubular shape at a central portion of the stator yoke 13 by press fitting or adhesion or by both press fitting and adhesion. Incidentally, the holder 16 in which the bearing unit 30 is press fitted is formed in a tubular shape and as one body with the stator yoke 13.

As shown in FIG. 1, the core 15 around which the coil 14 supplied with a driving current is supplied is attached to an outer peripheral part of the bearing unit 30 integrally fixed to the stator yoke 13.

The rotor 11 constituting the motor 1 together with the stator 12 is attached to a rotating shaft 31 borne by the bearing unit 30 so as to be capable of rotation, and is rotated as one body with the rotating shaft 31. The rotor 11 includes a rotor yoke 17, and the fan 3 having a plurality of vanes 19 rotated as one body with the rotor yoke 17. The vanes 19 of the fan 3 are formed to be integral with the rotor yoke 17, by outsert molding on the outer peripheral surface of the rotor yoke 17.

On the inner peripheral surface of a tubular part 17a of the rotor yoke 17, a ring-like rotor magnet 20 is provided so as to face the coil 14 of the stator 12. The magnet 20 is a plastic magnet polarized to alternately have S and N poles along the circumferential direction, and is fixed to the inner peripheral surface of the rotor yoke 17 with an adhesive.

The rotor yoke 17 is so mounted as to be rotatable as one body with the rotating shaft 31, by a method in which a boss part 21 provided at a central portion of a flat plate part 17b and provided with a through-hole 21a is press fitted over an attaching part 32 provided at a tip side of the rotating shaft 31 borne by the bearing unit 30.

In the motor 1 configured as above, when a driving current in a predetermined current passing pattern is supplied from a driving circuit part provided outside the motor 1 to the coil 14 on the stator 12 side, the rotor 11 is rotated as one body with the rotating shaft 31, under the actions of a magnetic field generated in the coil 14 and magnetic fields supplied from the rotor magnet 20 on the rotor 11 side. With the rotor 11 thus rotated, the fan 3 having the plurality of vanes 19 and attached to the rotor 11 is also rotated, as one body with the rotor 11. With the fan 3 thus rotated, air in the exterior of the computer is sucked in through an opening provided in a casing constituting the computer, is distributed in the casing, and is then exhausted to the outside of the casing through a through-hole while being distributed in the heat sink provided inside the casing, whereby the heat generated from heat generating elements is released to the outside of the computer body, and the computer body is thereby cooled.

Now, the bearing unit 30 used in the motor 1 will be described further in detail.

As shown in FIGS. 1, 2 and 3, the bearing unit 30 rotatably bearing the rotating shaft 31 of the motor 1 described above includes a radial bearing 33 for bearing the rotating shaft 31 in the circumferential direction of the rotating shaft 31, a bearing holder member 34 as a first housing member provided on the outer periphery side and on the top face side as one end side in the axial direction of the radial bearing 33 and operative to hold the radial bearing 33, a case member 35 as a second housing member provided on the outer periphery side of the bearing holder member 34 and on the bottom face side as the other end side in the axial direction of the radial bearing 33, a lubricating oil 42 as a viscous fluid filling the inside of the bearing holder member 34 and the case member 35 united to each other, and a seal member 36 provided between the bearing holder member 34 and the case member 35 so as to seal the lubricating oil 42.

The radial bearing 33 is a slide bearing for bearing the rotating shaft 31 in the circumferential direction of the rotating shaft 31. Incidentally, while the radial bearing 33 is a slide bearing here, it is not restrictive; for example, the radial bearing 33 may be an oil-impregnated sintered bearing or a dynamic pressure fluid bearing.

The bearing holder member 34 as the first housing member is a member including a side surface part formed in a hollow cylindrical shape so as to contain the radial bearing 33 therein and surround the outer peripheral surface of the radial bearing 33, and a top face side part formed in such a shape as to surround the top face side of the radial bearing 33 exclusive of a shaft passage hole 41 described later, and is provided with a male screw part 34a at a cylindrical outer peripheral surface thereof. The bearing holder member 34 is formed, for example, from a metal by cutting.

The case member 35 as the second housing member is a member including a side surface part formed in a hollow cylindrical shape so as to surround the outer peripheral surface of the bearing holder 34, and a bottom face side part formed in such a shape as to surround the bottom face side of the radial bearing 33, and is provided at the cylindrical inner peripheral surface thereof with a female screw part 35a corresponding to the male screw part 34a of the bearing holder member 34. The case member 35 is formed, for example, from a metal by cutting.

Incidentally, while the bearing holder member 34 as the first housing member and the case member 35 as the second housing member are each formed from a metal by cutting here, they may each be formed by providing a pressed member with the screw part by form rolling, may each be formed by molding from a synthetic resin, with the screw part formed at the time of molding, or may be formed individually from different materials by different methods. Where the bearing holder member 34 and the case member 35 are each formed from a synthetic resin, the manufacturing process is simplified and a reduction in cost is realized. In addition, where the case member 35 is formed from a synthetic resin such as nylon, an excellent sealing property is obtained, so that the case member 35 can be used also as a seal member 36 which will be described later.

Besides, while in obtaining the bearing unit 30 the bearing holder member 34 and the case member 35 are molded individually and are integratedly assembled by fastening the male screw part 34a and the female screw part 35a to each other as will be described later, the case member 35 as the second housing member may be formed by outsert molding onto the bearing holder member 34 in the case where the case member 35 is formed from a synthetic resin.

The bearing holder member 34 and the case member 35 are integrated (united) with each other by fastening between the male screw part 34a formed at the outer peripheral surface of the bearing holder member 34 and the female screw part 35a formed at the inner peripheral surface of the case member 35. In addition, when fastened by the male screw part 34a and the female screw part 35a, the bearing holder member 34 and the case member 35 form a housing 37 which is hermetically sealed, excluding the shaft passage hole 41 provided in the bearing holder member 34. The housing 37 contains the radial bearing 33, and the inside thereof is filled with the lubricating oil 42 as above-mentioned.

Namely, the bearing holder member 34 and the case member 35 are integrated (united) with each other by the male screw part 34a and the female screw part 35a, contain the radial bearing 33 in a sealed condition, and form the housing 37 which has the shaft passage hole 41 permitting the rotating shaft 31 to pass therethrough on the top face side as one end side in the axial direction and which is internally filled with the lubricating oil 42.

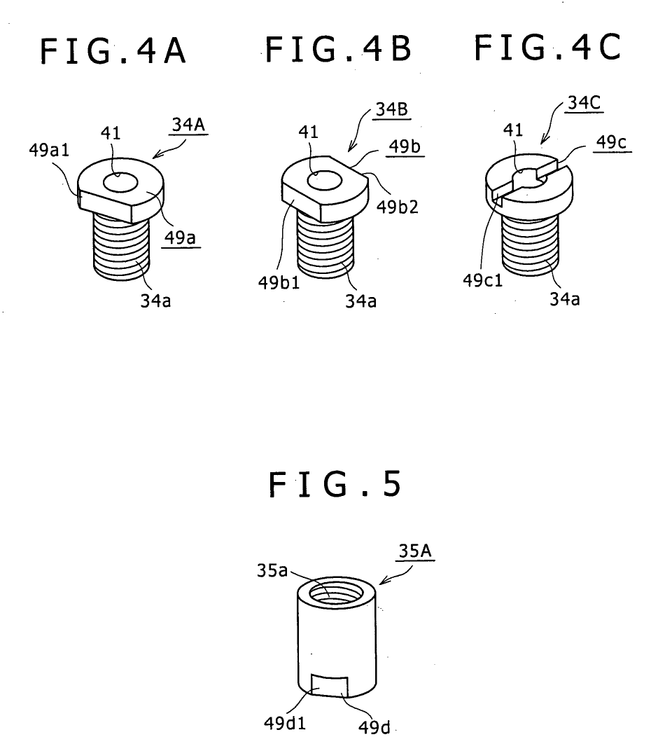

Incidentally, the bearing holder member 34 and/or the case member 35 may be provided with an anti-slip mechanism to be used at the time of the fastening, as shown in FIGS. 4A to 4C and 5. Specifically, the bearing holder member 34 constituting the bearing unit 30 may for example be a bearing holder member 34A which has an anti-slip mechanism 49a formed by the so-called D cutting wherein an engaging part 49a1 for engagement with a fastening tool such as a wrench, a minus screw driver, etc. is provided at one position of the outer peripheral surface on the top face side as shown in FIG. 4A, or may be a bearing holder member 34B which has an anti-slip mechanism 49b composed of engaging parts 49b1 and 49b2 provided at two positions of the outer peripheral surface on the top face side as shown in FIG. 4B, or may be a bearing holder member 34C which has an anti-slip mechanism 34C composed of an engaging groove 49c1 in the top face thereof as shown in FIG. 4C. On the other hand, the case member 35 constituting the bearing unit 30 may for example be a case member 35A having an anti-slip mechanism 49d formed by the so-called D cutting wherein an engaging part 49d1 for engagement with a fastening tool is provided at one position of the outer peripheral surface on the bottom face side as shown in FIG. 5, or may be a case member having an anti-slip mechanism composed of engaging parts provided at two positions of the outer peripheral surface on the bottom face side, or may be a case member having an anti-slip mechanism composed of an engaging groove provided in the bottom face thereof. Where the bearing holder member and/or the case member is provided with the anti-slip mechanism, assembly is facilitated, and the assembling process can be simplified.

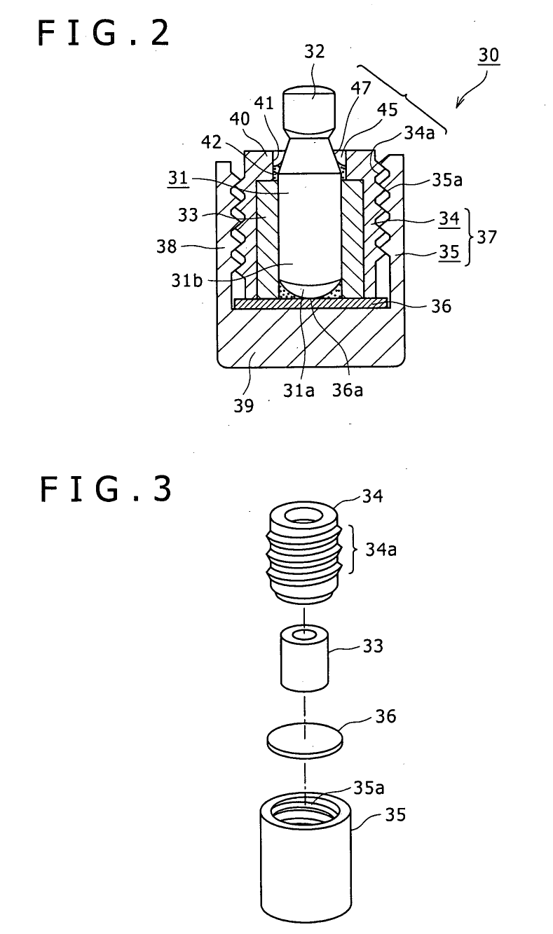

As shown in FIG. 2, the housing 37 having the bearing holder member 34 and the case member 35 united together includes a tubular housing body 38, a bottom closing part 39 constituting the other end side part formed as one body with the case member 35 so as to close the bottom face side of the housing body 38, and a top closing part 40 formed as one body with the bearing holder member 34 for constituting the top face side of the housing body 38. The top closing part 40 is provided in its central portion with a shaft passage hole 41 through which the rotating shaft 31 rotatably borne by the radial bearing 33 contained in the housing 37 is passed.

The seal member 36 is provided between the bearing holder member 34 and the case member 35 so as to prevent the lubricating oil 42 from leaking through a gap between the bearing holder member 34 and the case member 35 united together. To be more specific, the case member 36 is disposed on the inner surface side of the bottom closing part 39 of the case member 35, and is clamped between an end part on the bottom face side of a hollow cylindrically shaped-part of the bearing holder member 34 containing the radial bearing 33 and the bottom closing part 39 of the case member 35, by the fastening force of the male screw part 34a and the female screw part 35a, whereby the leakage of the lubricating oil 42 filling the housing 37 can be prevented securely. In other words, the seal member 36 is clamped between the end part serving as a contact part of the bearing holder member 34 and the bottom closing part 39 serving as a contact part of the case member 35, whereby leakage of the lubricating oil 42 can be prevented.

Examples of the material which can be used for constituting the seal member 36 include polymeric materials such as nylon, rubber and soft metals such as copper. In addition, here, nylon to be a sliding member is used as the material constituting the seal member 36, whereby it is used also as a pivot-type thrust bearing 36a as will be described later.

The bearing unit 30 has a configuration in which the seal member 36 is clamped at the time of uniting the bearing holder member 34 and the case member 35, whereby configuration and assembling process are simplified. Besides, since the housing 37 configured by uniting the bearing holder member 34 and the case member 35 can be sealed, exclusively of the shaft passage hole 41, in the manner of preventing the leakage via the fastened surfaces of the bearing holder member 34 and the case member 35, the leakage of the viscous fluid such as the lubricating oil can be prevented.

In addition, while the seal member 36 is provided in the bearing unit 30, the configuration in which the bearing holder member 34 or the case member 35 is formed of a synthetic resin or the like as above-mentioned makes it possible to obtain the same effect as that of the seal member. Specifically, in a bearing unit in which the seal member is not provided, the end part on the bottom face side of the hollow cylindrically shaped part of the bearing holder member 34 containing the radial bearing 33 and the bottom closing part 39 of the case member 35 are put in contact with each other and pressed against each other, by the fastening force between the male screw part 34a and the female screw part 35a at the time of uniting the bearing holder member 34 and the case member 35, whereby leakage of the lubricating oil 42 filling the housing 37 can be prevented assuredly. In other words, the contact surface of the bearing holder member 34 or the case member 35 that is formed of a synthetic resin or the like displays a function as a seal member.

Besides, even in the case where the seal member 36 is not provided in the bearing unit 30, the configuration in which the bearing holder member 34 or the case member 35 is formed of a synthetic resin or a soft metal or the like as above-mentioned ensures that the fastening surfaces themselves of the male screw part 34a and the female screw part 35a have a high sealing function. As a result, the leakage of the lubricating oil 42 filling the housing 37 can be securely prevented by the fastening parts of the male screw part 34a and the female screw part 35a, i.e., the fastening surface of the screw part, upon uniting the bearing holder 34 and the case member 35.

The seal member 36 disposed on the bottom closing part 39 of the housing 37 is integrally provided at a central portion on the inner surface side thereof with a thrust bearing 36a for rotatably bearing a bearing support part 31a provided at one end part in the thrust direction of the rotating shaft 31 borne by the radial bearing 33. Specifically, the thrust bearing 36a is used also as a seal member due to the configuration in which the seal member 36 is formed of nylon or the like to be a sliding member. The thrust bearing 36a is formed as a pivot bearing which bears, on a point basis, the bearing support part 31a of the rotating shaft 31 formed in an arcuate shape or a tapered shape.

Incidentally, while nylon is used here as the material of the seal member 36 so that the thrust bearing 36a is formed as a part of the seal member 36, a configuration may be adopted in which the thrust bearing is formed independently and disposed on the seal member. Also, a configuration may be adopted in which the thrust bearing is provided as one body with the bottom closing part 39 and the seal member is provided with a roughly circular opening so that the rotating shaft 31 can be borne by the thrust bearing.

The rotating shaft 31 rotatably borne by the thrust bearing 36a provided as one body with the seal member 36 has a configuration in which the bearing support part 31a, borne by the thrust bearing 36a, of a shaft part body 31b is formed in an arcuate shape or a tapered shape, and an attaching part 32 to which a rotating body, e.g., the rotor 11 of the motor 1 is attached is provided on the other end side. Here, the shaft part body 31b and the attaching part 32 are formed to be equal in diameter.

As shown in FIG. 2, the rotating shaft 31 has a configuration in which the bearing support part 31a on one end side thereof is borne by the thrust bearing 36a, the outer peripheral surface of the shaft part body 31b thereof is borne by the radial bearing 33, and the side of the attaching part 32 provided on the other end side protrudes via the shaft passage hole 41, provided in the top closing part 40 of the housing body 38, to be supported by the housing 37.

The shaft passage hole 41 is formed to have an inside diameter slightly larger than the outside diameter of the shaft part body 31b so that the rotating shaft 31 passed through the shaft passage hole 41 can be rotated without making frictional contact with the inner peripheral surface of the shaft passage hole 41. In this case, the shaft passage hole 41 is so formed that a cavity 45 having a spacing sufficient for preventing the lubricating oil 37 filling the inside of the housing 37 from leaking from the housing 37 is provided between the inner peripheral surface of the shaft passage hole 41 and the outer peripheral surface of the shaft part body 31b. Thus, the top closing part 40 provided with the shaft passage hole 41 so that the cavity 45 for preventing the leakage of the lubricating oil 42 filling the inside of the housing 37 is formed between the shaft passage hole 41 and the rotating shaft 31 constitutes an oil seal part.

The outer peripheral surface, facing the inner peripheral surface of the shaft passage hole 41, of the rotating shaft 31 is provided with a tapered part 47. The tapered part 47 is so inclined that the cavity 45 formed between the outer peripheral surface of the rotating shaft 31 and the inner peripheral surface of the shaft passage hole 41 is enlarged along the direction toward the outside of the housing. The tapered part 47 produces a pressure gradient in the cavity 45 formed between the outer peripheral surface of the rotating shaft 31 and the inner peripheral surface of the shaft passage hole 41, whereby a force for pulling the lubricating oil 42 filling the inside of the housing 37 toward the inside of the housing 37 is generated, and leakage of the lubricating oil 42 is prevented.

Incidentally, while the tapered part 47 is provided on the rotating shaft 31 side in the above-described bearing unit 30, the inner peripheral surface of the shaft passage hole 41 on the housing 37 side may be provided with a tapered part.

The bearing unit 30 configured as above-mentioned is assembled by a method in which, as shown in FIG. 3, the seal member 36 is disposed on the bottom closing part 39 of the case member 35, the radial bearing 33 is attached to the bearing holder member 34, then the bearing holder member 34 and the case member 35 are united by fastening the male screw part 34a and the female screw part 35a to each other, thereby forming the housing 37, the rotating shaft 31 is passed through the radial bearing 33 starting from the shaft passage hole 41 of the housing 37, and the inside of the housing 37 is filled with the lubricating oil 42. In this case, as above-mentioned, the bearing holder member 34 and the case member 35 are united by fastening the male screw part 34a and the female screw part 35a to each other, and the inside of the housing 37 is sealed, exclusively of the shaft passage hole 41.

In the bearing unit 30, the radial bearing 33 is clampedly held by the male screw part 34a provided at the outer periphery of the bearing holder member 34 and the female screw part 35a provided at the inner periphery of the case member 35, whereby a sealing sufficient for preventing the leakage of the lubricating oil can be achieved without providing a troublesome sealing step, so that a good lubrication with low cost and excellent reliability can be obtained. In addition, the bearing unit 30 has the male screw part 34a and the female screw part 35a provided respectively at the outer peripheral surface and at the inner peripheral surface, so that an increase in the size in the axial direction of the housing 37 is obviated, reductions in thickness and size can be realized, and simple fastening can be attained.

As above-mentioned, the bearing unit 30 according to an embodiment of the present invention has a configuration wherein the bearing holder member 34 provided on the outer peripheral side and on one end side in the axial direction of the radial bearing 33 and operative to hold the radial bearing 33 and the case member 35 provided on the outer periphery side of the bearing holder member 34 and on the other end side in the axial direction of the radial bearing 33 are united together, by fastening the male screw part 34a provided on the outer periphery side of the bearing holder member 34 and the female screw part 35a provided on the inner periphery side of the case member 35, to thereby constitute the housing 37, and the inside of the housing 37 can be sealed, exclusively of the shaft passage hole 41 provided on one end side in the axial direction. Therefore, leakage of the lubricating oil can be prevented, the configuration can be simplified, and the assembly can be carried out easily.

Besides, in the bearing unit 30 according to an embodiment of the present invention, the seal member 36 is provided between the bearing holder member 34 and the case member 35, so that assured packing can be realized by the seal member 36. In addition, the inside of the housing 37 exclusive of the shaft passage hole 41 can be sealed by performing the packing simultaneously with uniting the bearing holder member 34 and the case member 35 through fastening the male screw part 34a and the female screw part 35a. Therefore, the configuration of the bearing unit 30 can be simplified and reduced in size, the assembly process can be simplified, and leakage of the lubricating oil as a viscous fluid can be securely prevented, whereby reliability can be further enhanced.

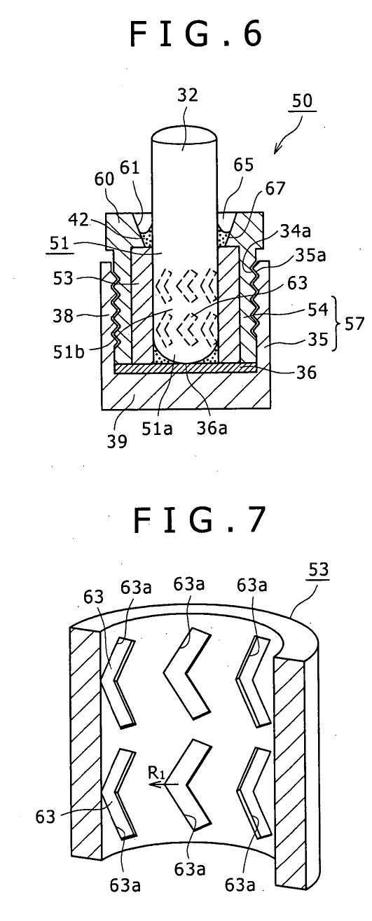

Incidentally, while a slide bearing is used as the radial bearing 33 in the above-described bearing unit 30, a dynamic pressure fluid bearing may be used as the radial bearing constituting the bearing unit, as above-mentioned. A bearing unit in which a dynamic pressure fluid bearing is used as the radial bearing may be configured, for example, as shown in FIG. 6. In the following description, the same parts as those of the bearing unit 30 shown in FIG. 2 are denoted by the same symbols as used above, and descriptions of these parts will be omitted.

The bearing unit 50 shown in FIG. 6 includes a radial bearing 53 for bearing a rotating shaft 51 in the circumferential direction of the rotating shaft 51, a bearing holder member 54 provided on the outer periphery side and on the top face side in the axial direction of the radial bearing 53 and operative to hold the radial bearing 53, a case member 35 provided on the outer periphery side of the bearing holder member 54 and on the bottom face side in the axial direction of the radial bearing 53, a lubricating oil 42 placed to fill the inside of a housing 57 configured by uniting the bearing holder member 54 and the case member 35, and a seal member 36 provided between the bearing holder member 54 and the case member 35.

The radial bearing 53 is formed of a sintered metal in a hollow cylindrical shape. The radial bearing 53 constitutes a dynamic pressure fluid bearing together with the lubricating oil 42 which is a viscous fluid filling the inside of the housing 57, and dynamic pressure generating grooves 63 are formed at the inner peripheral surface along which the rotating shaft 51 is passed.

As shown in FIG. 7, the dynamic pressure generating grooves 63 have a configuration in which the inner peripheral surface of the radial bearing 53 is provided with a plurality of pairs of grooves 63a, the pairs being arrayed in the circumferential direction and each pair being V-shaped. The dynamic pressure generating grooves 63 are so formed that the tip side of each V-shaped pair of grooves 63a is directed in the rotating direction R1 of the rotating shaft 51. Here, the dynamic pressure generating grooves 63 are formed in two arrays which are arranged on the upper and lower sides in the axial direction of the hollow cylindrical radial bearing 53. The number and the size of the dynamic pressure generating grooves 63 provided in the radial bearing 53 are appropriately selected according to the size, length and the like of the radial bearing 53. Incidentally, the radial bearing 53 may be formed of brass, stainless steel or a polymeric material.

In the radial bearing 53 formed as a dynamic pressure fluid bearing, when the rotating shaft 51 passed through the radial bearing 53 is continuously rotated about its center axis CL in the direction of arrow R1 in FIG. 7, the lubricating oil 42 filling the inside of the housing 57 is circulated in the dynamic pressure generating grooves 63 to generate a dynamic pressure between the outer peripheral surface of the rotating shaft 51 and the inner peripheral surface of the radial bearing 53, thereby bearing the rotating shaft 51 in rotation. The dynamic pressure generated in this instance realizes smooth rotation of the rotating shaft 51.

The bearing holder member 54 as a first housing member is a member including a side surface part formed in a hollow cylindrical shape so as to contain the radial bearing 53 and surround the outer peripheral surface of the radial bearing 53, and a top face side part formed in such a shape as to surround the top face side of the radial bearing 53 exclusive of a shaft passage hole 61 which will be described later. The bearing holder member 54 is provided at the cylindrical outer peripheral surface thereof with a male screw part 34a, in the same manner as in the case of the above-described bearing holder member 34. Incidentally, the bearing holder member 54 is formed from the same material by the same method as in the case of the above-described bearing holder member 34.

The bearing holder member 54 and the case member 35 are united by fastening the male screw part 34a and the female screw part 35a to each other, to constitute a housing 57 which is sealed exclusively of the shaft passage hole 61 provided in the bearing holder member 54. The housing 57 contains the radial bearing 53, and its inside is filled with the lubricating oil 42, as above-mentioned.

Namely, the bearing holder member 54 and the case member 35 are united by the male screw part 34a and the female screw part 35a to constitute the housing 57, which contains the radial bearing 53 in a sealed condition and is provided on the top face side as one end side in the axial direction thereof with the shaft passage hole 61 permitting the rotating shaft 51 is pass therethrough, and the inside of the housing 57 is filled with the lubricating oil 42.

Incidentally, the bearing holder member 54 also may be provided with an anti-slip mechanism as shown in FIG. 4A to 4C, in the same manner as the above-described bearing holder member 34.

As shown in FIG. 6, the housing 57 formed by uniting the bearing holder member 54 and the case member 35 includes a housing body 38, a bottom closing part 39 closing the bottom face side of the housing body 38, and a top closing part 60 formed as one body with the bearing holder member 54 for constituting the top face side of the housing body 38. The top closing part 60 is provided in its central portion with the shaft passage hole 61 through which to pass the rotating shaft 51 rotatably borne by the radial bearing 53 contained in the housing 57.

The seal member 36 is provided between the bearing holder member 54 and the case member 35, and prevents the lubricating oil 42 from leaking through the gap between the bearing holder member 54 and the case member 35 united together. Specifically, the seal member 36 is disposed on the inner periphery side of the bottom closing part 39 of the case member 35, and is clamped between an end part on the bottom face side of a hollow cylindrically shaped part of the bearing holder member 54 containing the radial bearing 53 and the bottom closing part 39 of the case member 35, by the fastening force of the male screw part 34a and the female screw part 35a, whereby the lubricating oil 42 filling the inside of the housing 57 can be securely prevented from leaking.

The bearing unit 50 has a configuration in which the seal member 36 is clamped upon uniting the bearing holder member 54 and the case member 35, whereby configuration and assembly process are simplified, the leakage via the fastened surfaces of the bearing holder member 54 and the case member 35 is prevented, and the housing 57 formed by uniting the bearing holder member 54 and the case member 35 can be sealed, exclusively of the shaft passage hole 61, so that the leakage of the viscous fluid such as the lubricating oil can be prevented.

In addition, the functions and effects in the case where the seal member is not provided in the bearing unit 50 and in the case where the bearing holder member or the case member is formed of a synthetic resin, a comparatively soft metal or the like, are the same as described in the case of the above-described bearing unit 30, and, therefore, detailed description thereof is omitted here.

The rotating shaft 51 rotatably borne by a thrust bearing 36a provided as one body with the seal member 36 has a configuration in which a bearing support part 51a, borne by the thrust bearing 36a, of a shaft part body 51b is formed in an arcuate shape or a tapered shape, and is provided on the other end side with an attaching part 32 to which a rotating body, for example, a rotor 11 of a motor 1 is attached. Here, the shaft part body 51b and the attaching part 32 are equal in diameter.

As shown in FIG. 6, the rotating shaft 51 is borne in the housing 57 in the condition where the bearing support part 51a on one end side thereof is borne by the thrust bearing 36a, the outer peripheral surface of the shaft part body 51b is borne by the radial bearing 53, and the side of the attaching part 32 provided on the other end side thereof is projected through the shaft passage hole 61 provided in the top closing part 60 of the housing body 38.

The shaft passage hole 61 is formed to have an inside diameter slightly larger than the outside diameter of the shaft part body 51b so that the rotating shaft 51 passed through the shaft passage hole 61 can be rotated without making frictional contact with the inner peripheral surface of the shaft passage hole 61. In this case, the shaft passage hole 61 is so formed that a cavity 65 with a spacing sufficient for preventing the lubricating oil 42 filling the inside of the housing 57 from leaking out from the inside of the housing 57 is provided between the inner peripheral surface of the shaft passage hole 61 and the outer peripheral surface of the shaft part body 51b. Thus, the top closing part 60 provided with the shaft passage hole 61 so that the cavity 65 satisfactory for preventing the leakage of the lubricating oil 42 filling the inside of the housing 57 is formed between the top closing part 60 and the rotating shaft 51 constitutes an oil seal part.

The inner peripheral surface, facing the outer peripheral surface of the rotating shaft 51, of the shaft passage hole 61 is provided with a tapered part 67. The tapered part 67 is so inclined that a cavity 65 formed between the outer peripheral surface of the rotating shaft 51 and the inner peripheral surface of the shaft passage hole 61 is enlarged along the direction toward the outside of the housing 57. The tapered part 67 produces a pressure gradient in the cavity 65 defined by the outer peripheral surface of the rotating body 51 and the inner peripheral surface of the shaft passage hole 61, thereby generating a force for pulling the lubricating oil 42 filling the inside of the housing 57 into the inside of the housing 57. Since the lubricating oil 42 is pulled into the inside of the housing 57 when the rotating shaft 51 is rotated, the lubricating oil 42 securely enters into dynamic pressure generating grooves 63 in the radial bearing 53 configured by the dynamic pressure fluid bearing, to generate a dynamic pressure, whereby stable bearing of the rotating shaft 51 is realized, and the lubricating oil 42 filling the inside of the housing 57 can be prevented from leaking.

In the bearing unit 50, the lubricating oil 42 entering into the dynamic pressure generating grooves 63 provided in the radial bearing 53 constituting the dynamic pressure fluid bearing so as to generate the dynamic pressure is so placed as to front, from the inside of the housing 57, on the cavity 65 defined by the tapered part 67 possessed by the rotating shaft 51 and the inner peripheral surface of the shaft passage hole 61. Specifically, the lubricating oil 42 fills the gaps in the inside of the housing 57, and, further, the radial bearing 53 composed of a sintered metal is impregnated with the lubricating oil 42.

In the bearing unit 50 according to an embodiment of the present invention, the bearing holder member 54 provided on the outer periphery side and on one end side in the axial direction of the radial bearing 53 and operative to hold the radial bearing 53 and the case member 35 provided on the outer periphery side of the bearing holder member 54 and on the other end side in the axial direction of the radial bearing 53 are united, by fastening the male screw part 34a provided on the outer periphery side of the bearing holder member 54 and the female screw part 35a provided on the inner periphery side of the case member 35 to each other, so as to constitute the housing 57, and, at the same time, the inside of the housing 57 can be sealed exclusively of the shaft passage hole 61. Therefore, leakage of the lubricating oil can be prevented, the configuration can be simplified, and the assembly can be carried out easily.

Further, in the bearing unit 50 according to an embodiment of the present invention, the use of the radial bearing 53 formed as a dynamic pressure fluid bearing realizes a smoother rotating performance. In addition, the lubricating oil can be retained securely and sufficiently even for the radial bearing 53 provided as the dynamic pressure fluid bearing for which the retention of the lubricating oil is more important as compared with the case of the above-mentioned radial bearing 33 provided as a slide bearing; therefore, a good rotation performance is obtained over a long time, and simplification of configuration and assembly process can be attained.

Besides, in the bearing unit 50 according to an embodiment of the present invention, the seal member 36 is provided between the bearing holder member 54 and the case member 35, whereby assured packing can be realized by the seal member 36. The inside of the housing 57 exclusive of the shaft passage hole 61 can be sealed, by performing the packing simultaneously with uniting the bearing holder member 54 and the case member 35 through fastening the male screw part 34a and the female screw part 35a to each other. Therefore, the configuration of the bearing unit 50 can be simplified and reduced in size, the assembly process can be simplified, and the leakage of the lubricating oil as the viscous fluid can be prevented more assuredly, whereby reliability can be enhanced more.

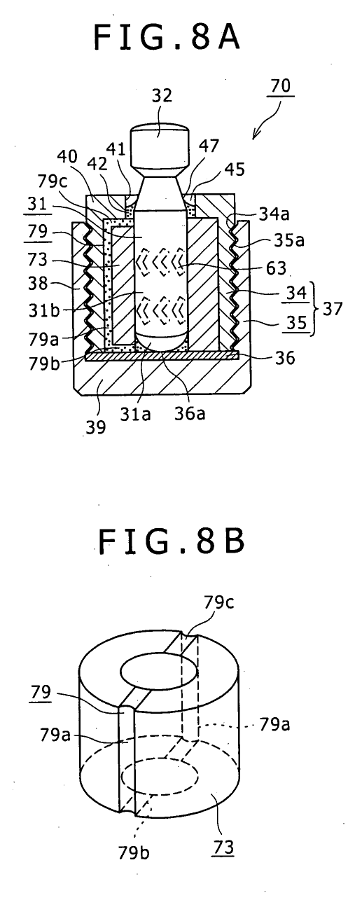

Incidentally, the bearing unit according to an embodiment of the present invention is not limited to the above-described bearing units 30 and 50. For example, as shown in FIG. 8A, the bearing unit may have a configuration in which a communicating passage for communication between one end side and the other end side in the thrust direction of a rotating shaft protruding from a radial bearing. Incidentally, in the following description, the same parts as those in the bearing units 30 and 50 shown in FIGS. 2 and 6 above will be denoted by the same symbols as used above, and detailed descriptions thereof will be omitted.

The bearing unit 70 shown in FIG. 8A includes a radial bearing 73 for bearing a rotating shaft 31 in the circumferential direction of the rotating shaft 31, a bearing holder member 34 provided on the outer periphery side and on the top face side in the axial direction of the radial bearing 73 and operative to hold the radial bearing 73, a case member 35 provided on the outer periphery side of the bearing holder member 34 and on the bottom face side in the axial direction of the radial bearing 73, a lubricating oil 42 filling the inside of a housing 37 configured by uniting the bearing holder member 34 and the case member 35, a seal member 36, and a communicating passage 79 formed between the housing 37 and the radial bearing 73.

Like the above-described radial bearing 53, the radial bearing 73 is formed of a sintered metal, and constitute a dynamic pressure fluid bearing together with the lubricating oil 42 filling the inside of the housing 37. The inner peripheral surface, along which the rotating shaft 31 is passed, of the radial bearing 73 is provided with dynamic pressure generating grooves 63 in the same manner as in the case of the above-described radial bearing 53.

When the rotating shaft 31 passed through the radial bearing 73 formed as a dynamic pressure fluid bearing is rotated, the lubricating oil 42 filling the inside of the housing 37 is circulated in the dynamic pressure generating grooves 63, to generate a dynamic pressure between the outer peripheral surface of the rotating shaft 31 and the inner peripheral surface of the radial bearing 73, thereby bearing the rotating shaft 31 in rotation. The dynamic pressure generated in this instance realizes a smooth rotation of the rotating shaft 31.

Incidentally, while the radial bearing 73 is formed as the so-called dynamic pressure fluid bearing which has the dynamic pressure generating grooves, this is not limitative of the radial bearing constituting the bearing unit according to an embodiment of the present invention, and the radial bearing can have various configurations insofar as the radial bearing bears a rotating shaft in the circumferential direction of the rotating shaft. For example, a slip bearing, an oil-impregnated sintered bearing and the like may also be adopted.

As shown in FIG. 8B, the communicating passage 79 includes first grooves 79a formed in the outer peripheral surface of the radial bearing 73 in the thrust direction, a second groove 79b formed in one end face on the thrust bearing 36a side of the radial bearing 73, and a third bearing 79c formed in the other end face of the radial bearing 73.

Thus, the bearing holder member 34 constituting the housing 37 and the case member 35 constituting the housing 37 have also the function as passage forming members for forming the communicating passage 79 between the radial bearing 73 and the housing 37.

The communicating passage 79 provides communication between the open side and the non-open side of the rotating shaft 31 protruding from the radial bearing 73. Therefore, even when the rotating shaft 31 and the housing 37 are rotated relative to each other and a dynamic pressure is thereby generated, the static pressure at a shaft end on the non-exposed shaft side, or the side where the rotating shaft 31 is not open, can be prevented from being lowered. Accordingly, the communicating passage 79 can prevent the push-out of the lubricating oil due to the expansion of the residual air in the housing 37 or the air dissolved in the lubricating oil, which might be generated if the internal static pressure is lowered. In other words, the communicating passage 79 provides a short-circuit between the pressures at both ends of the radial bearing 73, so that a pressure difference would not be generated between both ends, and, therefore, lifting of the shaft due to such a pressure difference would not be generated.

The bearing unit 70 is of the so-called shaft both end open type wherein both ends of the rotating shaft 71 protruding from the radial bearing 73 are made to communicate with each other by providing the communicating passage 79. In a shaft both end open type bearing unit according to the related art, there has been the problem that the lubricating oil would easily be scattered by shocks. In the present bearing unit 70, the housing 37 is sealed exclusively of the shaft passage hole 41, so that sealing from the exterior is achieved exclusively of the shaft passage hole 41 provided in the housing 37, notwithstanding the shaft open side and the shaft non-open side of the rotating shaft 31 protruding from the radial bearing 73 are made to communicate with each other by the communicating passage 79. In other words, since the communicating passage 79 in the bearing unit 70 is provided in the inside of the housing 37 which is sealed from the exterior, the scattering of the lubricating oil by shocks can be prevented.

In the bearing unit 70, the seal member 36 is clamped at the time of uniting the bearing holder member 34 and the case member 35, whereby configuration and assembly process of the bearing unit 70 are simplified. In addition, leakage via the fastened surfaces of the bearing holder member 34 and the case member 35 is prevented, and the housing 37 formed by uniting the bearing holder member 34 and the case member 35 can be sealed exclusively of the shaft passage hole 41. Therefore, the viscous fluid such as the lubricating oil can be prevented from leaking.

Besides, in the bearing unit 70, the functions and effects in the case where the seal member is not provided and in the case where the bearing holder member or the case member is formed of a synthetic resin, a comparatively soft metal or the like are the same as described in the case of the above-mentioned bearing unit 30, and, therefore, detailed description thereof is omitted here.

In the bearing unit 70 according to an embodiment of the present invention, the bearing holder member 34 provided on the outer periphery side and on one end side in the axial direction of the radial bearing 73 and operative to hold the radial bearing 73 and the case member 35 provided on the outer periphery side of the bearing holder member 34 and on the other end side in the axial direction of the radial bearing 73 are united, by fastening the male screw part 34a provided on the outer periphery side of the bearing holder member 34 and the female screw part 35a provided on the inner periphery side of the case member 35 to each other, to form the housing 37, and, simultaneously, the inside of the housing 37 exclusive of the shaft passage hole 41 can be sealed. Therefore, the leakage of the lubricating oil can be prevented, the configuration of the bearing unit 70 can be simplified, and the bearing unit 70 can be assembled easily.

In addition, in the bearing unit 70 according to an embodiment of the present invention, the seal member 36 is provided between the bearing holder member 34 and the case member 35, whereby assured packing can be performed with the seal member 36. The inside of the housing 37 can be sealed exclusively of the shaft passage hole 41, by performing the packing simultaneously with uniting the bearing holder member 34 and the case member 35 through fastening the male screw part 34a and the female screw part 35a to each other. Therefore, the configuration of the bearing unit 70 can be simplified and reduced in size, the assembly process can be simplified, and the leakage of the lubricating oil as a viscous fluid can be securely prevented, whereby reliability can be further enhanced.

Furthermore, in the bearing unit 70 according to an embodiment of the present invention, the housing 37 is formed by uniting the bearing holder member 34 and the case member 35, and the communicating passage 79 is provided between the bearing holder member 34 and the case member 35 so as to make communication between one end side and the other end side in the thrust direction of the rotating shaft 31 protruding from the radial bearing 73. This ensures that, even when the rotating shaft 31 and the housing 37 are rotated relative to each other and a dynamic pressure is thereby generated, the internal static pressure is prevented from being lowered, the leak phenomenon in which the lubricating oil is pushed out by the expansion of the residual air in the housing 37 or the air dissolved in the lubricating oil can be prevented, and a good lubrication performance can be maintained. Therefore, the sealing of the inside of the housing 37 and the formation of the communicating passage 79 can be simultaneously achieved upon uniting the bearing holder member 34 and the case member 35, so that a simplified assembly process can be realized while contriving the prevention of leakage of the lubricating oil.

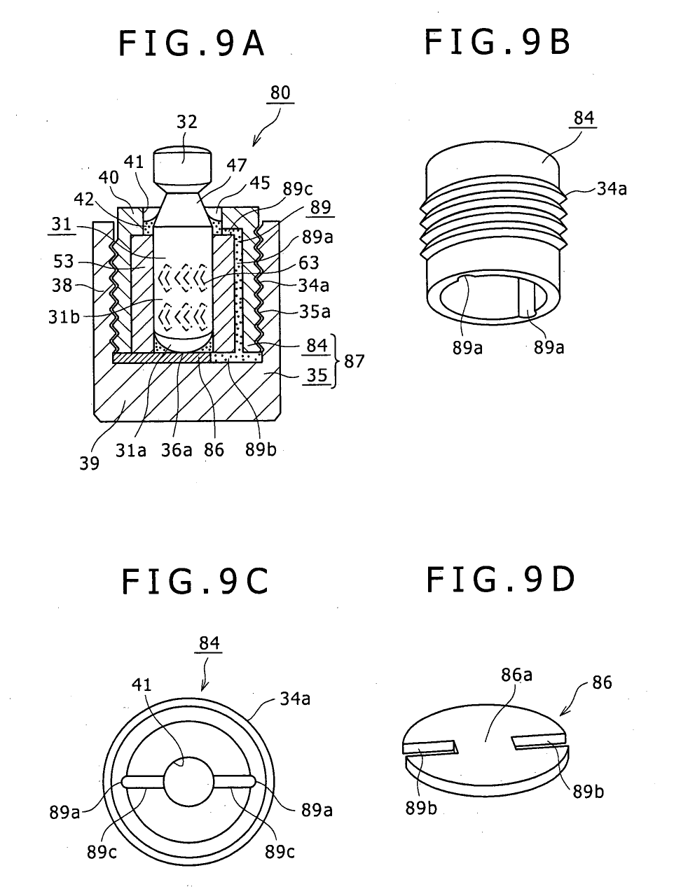

Incidentally, while the communicating passage 79 is composed of the first to third grooves provided on the radial bearing 33 side in the bearing unit 70 described above, the grooves constituting the communicating passage may be provided on the bearing holder member side. A bearing unit having a communicating passage on the bearing holder member side may be configured, for example, as shown in FIG. 9A. Incidentally, in the following description, the same parts as those in the bearing units 30, 50 and 70 shown in FIGS. 2, 6 and 8 will be denoted by the same symbols as used above, and detailed descriptions thereof will be omitted.

The bearing unit 80 shown in FIG. 9A includes a radial bearing 53 for bearing a rotating shaft 31 in the circumferential direction of the rotating shaft 31, a bearing holder member 84 as a first housing member provided on the outer periphery side and on the top face side in the axial direction of the radial bearing 53 and operative to hold the radial bearing 53, a case member 35 provided on the outer periphery side of the bearing holder member 84 and on the other end side in the axial direction of the radial bearing 53, a lubricating oil 42 filling the inside of a housing 87 formed by uniting the bearing holder member 84 and the case member 35, a seal member 86 for sealing the lubricating oil 42, and a communicating passage 89 formed between the housing 87 and the radial bearing 53.

The radial bearing 53 constitutes a dynamic pressure fluid bearing together with the lubricating oil 42, as above-mentioned, and its inner peripheral surface along which the rotating shaft 31 is passed is provided with dynamic pressure generating grooves 63. The radial bearing 53 formed as a dynamic pressure fluid bearing is so configured that, when the rotating shaft 31 is rotated, the lubricating oil 42 filling the inside of the housing 87 is circulated in the dynamic pressure generating grooves 63, to generate a dynamic pressure between the outer peripheral surface of the rotating shaft 31 and the inner peripheral surface of the radial bearing 53, thereby bearing the rotating shaft 31 in rotation. The dynamic pressure generated in this instance realizes smooth rotation of the rotating shaft 31.

The bearing holder member 84 as the first housing member is a member having a side surface part formed in a hollow cylindrical shape so as to contain the radial bearing 53 and surround the outer peripheral surface of the radial bearing 53, and a top face side part formed in such a shape as to surround the top face side of the radial bearing 53 exclusively of a shaft passage hole 41 described later, and a cylindrical outer peripheral surface of the bearing holder member 84 has a male screw part 34a in the same manner as the above-described bearing holder member 34. Incidentally, the bearing holder member 84 is formed of the same material by the same method as in the case of the above-described bearing holder member 34.

The bearing holder member 84 and the case member 35 are united by fastening the male screw part 34a and the female screw part 35a to each other, to constitute a housing 87 which is sealed exclusively of the shaft passage hole 41 provided in the bearing holder member 84. The housing 87 contains the radial bearing 53, and its inside is filled with the lubricating oil 42, as above-mentioned.

Namely, the bearing holder member 84 and the case member 35 are united by the male screw part 34a and the female screw part 35a to constitute the housing 87, which contains the radial bearing 53 in a sealed condition and is provided on the top face side as one end side in the axial direction thereof with the shaft passage hole 41 permitting the rotating shaft 31 is pass therethrough, and the inside of the housing 87 is filled with the lubricating oil 42.

Incidentally, the bearing holder member 84 also may be provided with an anti-slip mechanism as shown in FIG. 4A to 4C, in the same manner as in the case of the above described bearing holder member 34.

As shown in FIG. 9A, the housing 87 formed by uniting the bearing holder member 84 and the case member 35 includes a housing body 38, a bottom closing part 39 closing the bottom face side of the housing body 38, and a top closing part 40 formed as one body with the bearing holder member 84 to constitute the top face side of the housing body 38. The top closing part 40 is provided in its central portion with a shaft passage hole 41 permitting passage therethrough of the rotating shaft 31 rotatably borne by the radial bearing 53 contained in the housing 87.

As shown in FIGS. 9B, 9C and 9D, the communicating passage 89 includes first grooves 89a formed in the inner peripheral surface of a hollow cylindrically shaped side surface part of the bearing holder member 84, second grooves 89b formed on the radial bearing 53 side of the seal member 86, and third grooves 89c formed on the inner surface side of the top face of the bearing holder member 84. Incidentally, while the second grooves 89b are provided in the seal member 86 here, they may be provided in the inside surface of the bottom closing part 39 of the case member 35 serving as a second housing member, in the case where the sealing member is not provided. Besides, the communicating passage may be composed by combining the above-mentioned first grooves 79a provided on the radial bearing 73 side with second and third grooves 89b and 89c provided on the sides of the bearing holder member 84 and the seal member 86.

Thus, the bearing holder member 84 constituting the housing 87 and the seal member 86 disposed on the case member 35 constituting the housing 87 have also the function as passage forming members for forming the communicating passage 89 between the radial bearing 53 and the housing 87.

The communicating passage 89 establishes communication between the open side and the non-open side of the rotating shaft 31 protruding from the radial bearing 53; therefore, even when the rotating shaft 31 and the housing 87 are rotated relative to each other and a dynamic pressure is thereby generated, the static pressure at a shaft end on the shaft non-exposed side as the side where the rotating shaft 31 is not open can be prevented from being lowered. Accordingly, the communicating passage 89 can prevent the push-out of the lubricating oil due to the expansion of the residual air in the housing 87 or the air dissolved in the lubricating oil, which might be generated due to a lowering in the internal static pressure. In other words, the communicating passage 89 provides a short-circuit between the pressures at both ends of the radial bearing 53, so that a pressure difference would not be generated between both ends, and lifting of the shaft would not be generated by such a pressure difference.

The bearing unit 80 is of the so-called shaft both end open type in which both ends of the rotating shaft 31 protruding from the radial bearing 53 are made to communicate with each other. As above-mentioned, the bearing unity 80 has the structure in which the housing 87 is sealed exclusively of the shaft passage hole 41, so that sealing from the exterior is achieved exclusively of the shaft passage hole 41 provided in the housing 87, notwithstanding the shaft open side and the shaft non-open side of the rotating shaft 31 protruding from the radial bearing 87 communicate with each other via the communicating passage 89. In other words, the bearing unit 80 is so configured that the communicating passage 89 is provided inside the housing 87 sealed from the exterior, so that the lubricating oil can be prevented from being scattered upon shocks.

The seal member 86 is configured in the same manner as the above-described seal member 36, except that the second grooves 89b constituting the communicating passage 89 are provided. Namely, the seal member 86 is formed of the same material as that of the seal member 36, and is provided with a thrust bearing 36a.

The seal member 86 is provided between the bearing holder member 84 and the case member 35, and prevents the lubricating oil 42 from leaking through a gap between the bearing holder member 84 and the case member 35 which are united to each other. Specifically, the seal member 86 is disposed on the inner surface side of the bottom closing part 39 of the case member 35, and is clamped between an end part on the bottom face side of the hollow cylindrically shaped part of the bearing holder member 84 containing the radial bearing 35 and the bottom closing part 30 of the case member 35, by the fastening force of the male screw part 34a and the female screw part 35a, whereby the leakage of the lubricating oil 42 filling the inside of the housing 87 can be prevented assuredly.

The bearing unit 80 has the configuration in which the seal member 36 is clamped at the time of uniting the bearing holder member 84 and the case member 35, whereby the configuration and assembly process of the bearing unit 80 are simplified. In addition, leakage through the fastened surfaces of the bearing holder member 84 and the case member 35 is prevented, and the housing 87 exclusive of the shaft passage hole 41 can be sealed by uniting the bearing holder member 84 and the case member 35, so that the leakage of the viscous fluid such as the lubricating oil can be prevented.

Besides, in the bearing unit 80, the functions and effects in the case where the seal member is not provided and in the case where the bearing holder member or the case member is formed of a synthetic resin, a comparatively soft metal or the like are the same as described in the case of the above-mentioned bearing unit 30, and, therefore, detailed descriptions of them are omitted here.

In the bearing unit 80 according to an embodiment of the present invention, the bearing holder member 84 provided on the outer periphery side and on one end side in the axial direction of the radial bearing 53 and operative to hold the radial bearing 53 and the case member 35 provided on the outer periphery side of the bearing holder member 84 and on the other end side in the axial direction of the radial bearing 53 are united, by fastening the male screw part 34a provided on the outer periphery side of the bearing holder member 84 and the female screw part 35a provided on the inner periphery side of the case member 35 to each other, to constitute the housing 87, and the inside of the housing 87 can be sealed exclusively of the shaft passage hole 41. Therefore, the leakage of the lubricating oil can be prevented, the configuration of the bearing unit 80 can be simplified, and the assembly thereof can be carried out easily.

In addition, in the bearing unit 80 according to an embodiment of the present invention, the seal member 86 is provided between the bearing holder member 84 and the case member 35, whereby secure packing can be achieved by the seal member 86. Besides, the inside of the housing 87 can be sealed exclusively of the shaft passage hole 41, by performing the packing simultaneously with uniting the bearing holder member 84 and the case member 35 through fastening the male screw part 34a and the female screw part 35a to each other. Therefore, the configuration of the bearing unit 80 can be simplified and reduced in size, the assembly process thereof can be simplified, and the leakage of the lubricating oil as a viscous fluid can be prevented securely, whereby reliability can be enhanced further.

Furthermore, in the bearing unit 80 according to an embodiment of the present invention, the bearing holder member 84 and the case member 35 are united to form the housing 87, and the communicating passage 89 is formed between the bearing holder member 84 and the radial bearing 53 to establish communication between one end side and the other end side in the thrust direction of the rotating shaft 31 protruding from the radial bearing 53. This configuration ensures that, even when the rotating shaft 31 and the housing 87 are rotated relative to each other and a dynamic pressure is thereby generated, the internal static pressure is prevented from being lowered, and the leaking phenomenon in which the lubricating oil is pushed out due to the expansion of the residual air in the housing 87 or the air dissolved in the lubricating oil can be prevented, whereby a good lubrication performance can be maintained. Therefore, the sealing of the inside of the housing 87 and the formation of the communicating passage 89 can be simultaneously performed at the time of uniting the bearing holder member 84 and the case member 35, so that the assembly process can be simplified while contriving the prevention of leakage of the lubricating oil.

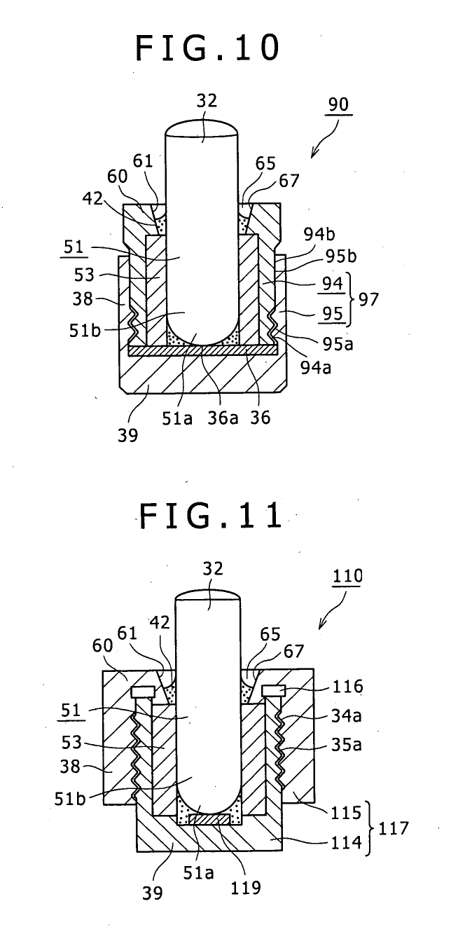

Furthermore, the bearing unit according to an embodiment of the present invention is not limited to the above-described bearing units 30, 50, 70 and 80, and axis adjusting means for adjusting the axial direction at the time of fastening the first housing member and the second housing member to each other may be provided. A bearing unit having such the axis adjusting means may be configured, for example, as shown in FIG. 10. Incidentally, in the following description, the same parts as those in the bearing units 30 and 50 shown in FIGS. 2 and 6 will be denoted by the same symbols as used above, and detailed descriptions of them will be omitted.

The bearing unit 90 shown in FIG. 10 includes a radial bearing 53 for bearing a rotating shaft 51 in the circumferential direction of the rotating shaft 51, a bearing holder member 94 provided on the outer periphery side and on the top face side in the axial direction of the radial bearing 53 and operative to hold the radial bearing 53, a case member 95 provided on the outer periphery side of the bearing holder member 94 and on the bottom face side in the axial direction of the radial bearing 53, a lubricating oil 42 filling the inside of a housing 97 formed by uniting the bearing holder member 94 and the case member 95, and a seal member 36 provided between the bearing holder member 94 and the case member 95.

The bearing holder member 94 as a first housing member is a member including a side surface part formed in a hollow cylindrical shape so as to contain the radial bearing 53 and surround the outer peripheral surface of the radial bearing 53, and a top face side part formed in such a shape as to surround the top face side of the radial bearing 53 exclusively of a shaft passage hole 61 which will be described later. The bearing holder member 94 has a male screw part 94a provided on an end part side, or the side for insertion into the case member 95, of the cylindrical outer peripheral surface thereof, and an axis adjusting part 94b provided on the base part side of the cylindrical outer periphery side thereof to be an attaching reference surface.

The case member 95 as a second housing member is a member including a side surface part formed in a hollow cylindrical shape so as to surround the outer peripheral surface of the bearing holder member 94, and a bottom face side part formed in such a shape as to surround the bottom face side of the radial bearing 53. The case member 95 has a female screw part 95a provided on the bottom side of the hollow cylindrical inner peripheral surface thereof and corresponding to the male screw part 94a of the bearing holder member 94, and an axis adjusting part 95b provided on the top face side part of the hollow cylindrical inner peripheral surface thereof to be an attaching reference surface.

Incidentally, the bearing holder member 94 and the case member 95 are formed of the same materials by the same methods as in the case of the bearing holder member 34 and the case member 35 described above.

The axis adjusting parts 94b and 95b to be attaching reference surfaces are formed in mutually corresponding sizes, and are formed in smooth peripheral surface shapes. The axis adjusting parts 94b and 95b function as axis adjusting means for adjusting the axial directions of the bearing holder member 94 and the case member 95, i.e., their coaxialness at the time of fastening them to each other. Specifically, the axis adjusting means composed of the axis adjusting parts 94b and 95b ensures that the case member 95 and the bearing holder member 95 can be attached so that the axial direction of the rotating shaft 51 borne by the radial bearing 53 held by the bearing holder member 94 is set in an appropriate condition relative to the case member 95 serving as an attaching reference.

The bearing holder member 94 and the case member 95 are united by fastening the male screw part 94a and the female screw part 95a to each other, and constitute a housing 97 sealed exclusively of a shaft passage hole 61 provided in the bearing holder member 94. The housing 97 contains the radial bearing 53, and the inside thereof is filled with the lubricating oil 42 as above-mentioned.

Specifically, the bearing holder member 94 and the case member 95 are united by the male screw part 94a and the female screw part 95a, to constitute the housing 97 which contains the radial bearing 53 in a sealed condition and is provided on the top face side as one end side in the axial direction thereof with the shaft passage hole 61 permitting passage therethrough of the rotating shaft 51, and the inside of the housing 97 is filled with the lubricating oil 42.

Incidentally, the bearing holder member 94 and the case member 95 may also be provided with anti-slip mechanisms as shown in FIGS. 4A to 4C and 5, in the same manner as the bearing holder member 34 and the case member 35 described above.

As shown in FIG. 10, the housing 97 formed by uniting the bearing holder member 94 and the case member 95 includes a housing body 38, a bottom closing part 39 closing the bottom face side of the housing body 38, and a top closing part 60 formed as one body with the bearing holder member 54 to constitute the top face side of the housing body 38. The top closing part 60 is provided in its central portion with the shaft passage hole 61 for passage therethrough of the rotating shaft 51 rotatably borne by the radial bearing 53 contained in the housing 57.

The seal member 36 is provided between the bearing holder member 94 and the case member 95, to prevent the lubricating oil 42 from leaking through a gap between the bearing holder member 94 and the case member 95 united with each other. To be more specific, the seal member 36 is disposed on the inner surface side of the bottom closing part 39 of the case member 95, and is clamped between an end part on the bottom face side of the hollow cylindrically shaped part of the bearing holder member 94 containing the radial bearing 53 and the bottom closing part 39 of the case member 95, by the fastening force of the male screw part 94a and the female screw part 95a, whereby the leakage of the lubricating oil 42 filling the inside of the housing 97 can be securely prevented.

The bearing unit 90 has the configuration in which the seal member 36 is clamped at the time of uniting the bearing holder member 94 and the case member 95, whereby the configuration and assembly process of the bearing unit 90 are simplified, and the leakage via the fastened surfaces of the bearing holder member 94 and the case member 95 is prevented. This configuration ensures that the housing 97 formed by uniting the bearing holder member 94 and the case member 95 can be sealed exclusively of the shaft passage hole 61, so that the leakage of the viscous fluid such as the lubricating oil can be prevented.

Besides, in the bearing unit 90, the functions and effects in the case where the seal member is not provided and in the case where the bearing holder member or the case member is formed of a synthetic resin, a comparatively soft metal or the like are the same as described in the case of the above-mentioned bearing unit 30, and, therefore, detailed descriptions of them are omitted here.

In the bearing unit 90 according to an embodiment of the present invention, the bearing holder member 94 provided on the outer periphery side and on one end side in the axial direction of the radial bearing 93 and operative to hold the radial bearing 93 and the case member 95 provided on the outer periphery side of the bearing holder member 94 and on the other end side in the axial direction of the radial bearing 93 are united, by the fastening between the male screw part 94a provided on the outer periphery side of the bearing holder member 94 and the female screw part 95a provided on the inner periphery side of the case member 95 to each other, to constitute the housing 97, and the inside of the housing 97 can be sealed exclusively of the shaft passage hole 61. Therefore, leakage of the lubricating oil can be prevented, the configuration of the bearing unit 90 can be simplified, and the assembly thereof can be easily carried out.

Besides, in the bearing unit 90 according to an embodiment of the present invention, the seal member 36 is provided between the bearing holder member 94 and the case member 95, whereby secure packing can be achieved with the seal member 36. In addition, the inside of the housing 97 can be sealed exclusively of the shaft passage hole 61, by performing the packing simultaneously with uniting the bearing holder member 94 and the case member 95 through fastening the male screw part 94a and the female screw part 95 to each other. Therefore, the configuration of the bearing unit 90 can be simplified and reduced in size, the assembly process thereof can be simplified, and the leakage of the lubricating oil as a viscous fluid can be prevented more assuredly, whereby reliability can be enhanced further.

Furthermore, in the bearing unit 90 according to an embodiment of the present invention, the axis adjusting means composed of the axis adjusting part 94b provided at the outer peripheral surface of the bearing holder member 94 and the axis adjusting part 95b provided at the inner peripheral surface of the case member 95 ensures that the bearing holder member 94 and the case member 95 can be fastened to each other, with their axes set in an appropriate condition, at the time of uniting them together. Therefore, the axial direction of the rotating shaft 51 borne by the radial bearing 53 which is determined by the axial direction of the bearing holder member 94 can be set in an appropriate condition relative to the outer peripheral surface of the case member 95, i.e., relative to the outer peripheral surface of the housing 97 at the time of assembly, and it is easy to maintain the coaxialness with high accuracy, so that the assembly process can be simplified, and reliability can be enhanced. Besides, in the case where the bearing unit 90 according to an embodiment of the present invention is attached, for example, to a motor or the like, the coaxialness of the rotating shaft 51 and the housing 97 which are attached respectively to a rotor part and a stator part can be set appropriately, so that a good rotation performance can be attained, and the steps of axis adjustment and the like in attaching the bearing unit to the motor or the like can be simplified.

Furthermore, the bearing unit according to an embodiment of the present invention is not limited to the bearing units 30, 50, 70, 80 and 90 described above, and the bearing unit may be configured, for example, as shown in FIG. 11. Incidentally, in the following description, the same parts as those in the bearing units 30 and 50 shown in FIGS. 2 and 6 respectively will be denoted by the same symbols as used above, and detailed description of them will be omitted.

The bearing unit 110 shown in FIG. 11 includes a radial bearing 53 for bearing a rotating shaft 51 in the circumferential direction of the rotating shaft 51, a bearing holder member 114 provided on the outer periphery side and on the bottom face side as one end side in the axial direction of the radial bearing 53 and operative to hold the radial bearing 53, a case member 115 provided on the outer periphery side of the bearing holder member 114 and on the top face side as the other end side in the axial direction of the radial bearing 53, a lubricating oil 42 filling the inside of a housing 117 formed by uniting the bearing holder member 114 and the case member 115, and a seal member 116 provided between the bearing holder member 114 and the case member 115.

The bearing holder member 114 as a first housing member is a member including a side surface part formed in a hollow cylindrical shape so as to contain the radial bearing 53 and surround the outer peripheral surface of the radial bearing 53, and a bottom face side part formed in such a shape as to surround the bottom face side of the radial bearing 53, and is provided with a male screw part 34a at the cylindrical outer peripheral surface thereof in the same manner as the above-described bearing holder member 34.

The case member 115 as a second housing member is a member including a side surface part formed in a hollow cylindrical shape so as to surround the outer peripheral surface of the bearing holder 114, and a top face side part formed in such a shape as to surround the top face side of the radial bearing 53 exclusively of a shaft passage hole 61 described later, and is provided with a female screw part 35a at the hollow cylindrical surface thereof in the same manner as the above-described case member 35.

Incidentally, the bearing holder member 114 and the case member 115 are formed of the same materials by the same methods as in the case of the bearing holder member 34 and the case member 35 described above.

The bearing holder member 114 and the case member 115 are united by fastening the male screw part 34a and the female screw part 35a to each other, to constitute the housing 117 having a sealed structure exclusively of the shaft passage hole 61 provided in the case member 115. The housing 117 contains the radial bearing 53, and the inside thereof is filled with the lubricating oil 42 as above-mentioned.

Specifically, the bearing holder member 114 and the case member 115 are united by the male screw part 34a and the female screw part 35a, to constitute the housing 117 which contains the radial bearing 53 in a sealed condition and which is provided on the top face side as the other end side in the axial direction thereof with the shaft passage hole 61 for passage of the rotating shaft 51 therethrough, and the inside of the housing 117 is filled with the lubricating oil 42.

Incidentally, the bearing holder member 114 and the case member 115 may also be provided with anti-slip mechanisms as shown in FIGS. 4A to 4C and 5, in the same manner as the bearing holder member 34 and the case member 35 described above.

As shown in FIG. 11, the housing 117 formed by uniting the bearing holder member 114 and the case member 115 includes a housing body 38, a bottom closing part 39 formed as one body with the bearing holder member 114 so as to close the bottom face side of the housing body 38, and a top closing part 60 formed as one body with the case member 115 to constitute the top face side of the housing body 38. The top closing part 60 is provided in its central portion with the shaft passage hole 61 for passage therethrough of the rotating shaft 51 rotatably borne by the radial bearing 53 contained in the housing 117.

The seal member 116 is provided between the bearing holder member 114 and the case member 115, and prevents the lubricating oil 42 from leaking through a gap between the bearing holder member 114 and the case member 115 united together. To be more specific, the seal member 116 is formed in a roughly circular annular shape, is disposed on the inner surface side of the top closing part 60 of the case member 115, and is clamped between an end part on the top face side of the hollow cylindrically shaped part of the bearing holder member 114 containing the radial bearing 53 and the top closing part 60 of the case member 115, by the fastening force of the male screw party 34a and the female screw part 35a, whereby leakage of the lubricating oil 42 filling the inside of the housing 117 can be securely prevented. Incidentally, the seal member 116 is formed of the same material as the above-described seal member 36.

In the bearing unit 110, the seal member 116 is clamped at the time of uniting the bearing holder member 114 and the case member 115, whereby the configuration and assembly process of the bearing unit 110 are simplified. In addition, leakage via the fastened surfaces of the bearing holder member 114 and the case member 115 is prevented, and the housing 117 formed by uniting the bearing holder member 114 and the case member 115 can be sealed exclusively of the shaft passage hole 61, so that leakage of the viscous fluid such as the lubricating oil can be prevented.

Besides, in the bearing unit 110, the functions and effects in the case where the seal member is not provided and in the case where the bearing holder member or the case member is formed of a synthetic resin, a comparatively soft metal or the like are the same as described in the case of the above-mentioned bearing unit 30, and, therefore, detailed descriptions of them are omitted here.

A thrust bearing 119 for rotatably bearing a bearing support part 51a provided at one end part in the thrust direction of the rotating shaft 31 borne by the radial bearing 53 is disposed on the bottom closing part 39 of the housing 117. Specifically, the thrust bearing 119 is formed of nylon or the like serving as a sliding member, and is formed as a pivot bearing which bears, on a point basis, the bearing support part 51 formed in an arcuate shape or a tapered shape, of the rotating shaft 51. Incidentally, the thrust bearing may be provided as one body with the bottom closing part 39.

The rotating shaft 51 rotatably borne by a thrust bearing 119 has a configuration in which a bearing support part 51a, borne by the thrust bearing 119, of a shaft body 51b is formed in an arcuate shape or a tapered shape, and is provided on the other end side with an attaching part 32 to which a rotating body, for example, a rotor 11 of a motor 1 is attached.

As shown in FIG. 11, the rotating shaft is borne in the housing 117 in the condition where the bearing support part 51a on one end side thereof is borne by the thrust bearing 119, the outer peripheral surface of the shaft part body 51b is borne by the radial bearing 53, and the side of the attaching part 32 provided on the other end side thereof is projected through the shaft passage hole 61 provided in the top closing part 60 of the housing body 38.

In the bearing unit 110 according to an embodiment of the present invention, the bearing holder member 114 provided on the outer periphery side and on one end side in the axial direction of the radial bearing 53 and operative to hold the radial bearing 53 and the case member 115 provided on the outer periphery side of the bearing holder member 114 and on the other end side in the axial direction of the radial bearing 53 are united, by fastening the male screw part 34a provided on the outer periphery side of the bearing holder member 114 and the female screw part 35a provided on the inner periphery side of the case member 115, to constitute the housing 117, and the inside of the housing 117 can be sealed exclusively of the shaft passage hole 61 provided on the other end side in the axial direction thereof, so that leakage of the lubricating oil can be prevented, the configuration of the bearing unit 110 can be simplified, and the assembly thereof can be easily carried out.

Besides, in the bearing unit 110 according to an embodiment of the present invention, the seal member 116 is provided between the bearing holder member 114 and the case member 115, whereby assured packing can be achieved with the seal member 116. In addition, the inside of the housing 117 exclusive of the shaft passage hole 61 can be sealed, by performing the packing simultaneously with uniting the bearing holder member 114 and the case member 115 through fastening the male screw part 34a and the female screw part 35a to each other. Therefore, the configuration of the bearing unit 110 can be simplified and reduced in size, the assembly process thereof can be simplified, and the leakage of the lubricating oil as a viscous fluid can be prevented more securely, whereby reliability can be enhanced more.

As has been described above, the bearing units 30, 50, 70, 80, 90 and 110 according to an embodiment of the present invention are inexpensive and excellent in reliability, and, therefore, are suitable for use in hard disk drives (HDD) needing assured restraint of the leakage of a lubricating oil, and for bearing units used in fan motors and the like required of a long life.

The motor 1 according to an embodiment of the present invention includes any one of the above-described bearing units 30, 50, 70, 80, 90 and 110, whereby the configuration thereof can be simplified and reduced in size, and the assembly process thereof can be simplified. In addition, it is possible to prevent the leakage of a viscous fluid such as a lubricating oil, to maintain a high rotation performance for a long time, and to enhance the reliability.

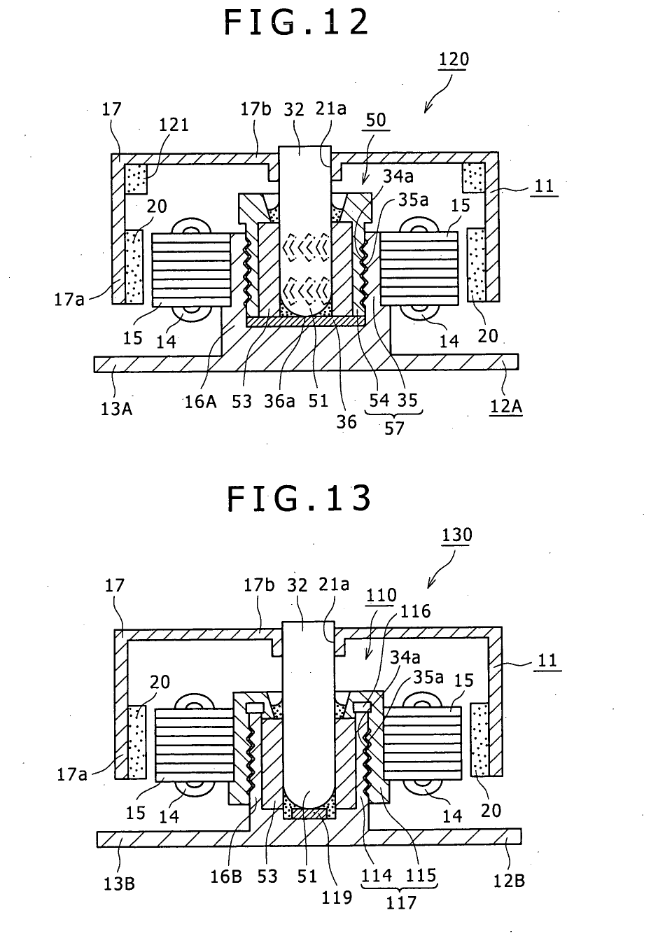

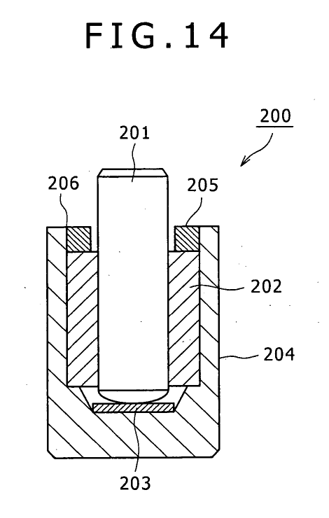

Incidentally, in the bearing unit and the motor according to an embodiment of the present invention, either of the bearing holder member and the case member which constitute the bearing unit may be formed as one body with a stator or a rotor of a motor. For example, a motor in which a case member of a bearing unit is formed as one body with the stator of the motor may be configured as shown in FIG. 12. Incidentally, the motor shown in FIG. 12 has a configuration in which the case member 35 of the bearing unit 50 shown in FIG. 6 above is formed as one body with the stator of the motor shown in FIG. 1, and, in the following description, the same parts as those in the motor shown in FIG. 1 and the bearing unit 50 shown in FIG. 6 will be denoted by the same symbols as used above, and detailed descriptions of them will be omitted.

The motor 120 shown in FIG. 12 includes a rotor 11 and a stator 12A. The stator 12A includes a stator yoke 13A, the above-described bearing unit 50 according to an embodiment of the present invention, a coil 14, and a core 15 around which the coil 14 is wound. As shown in FIG. 12, the bearing unit 50 has the above-mentioned case member 35 (which is one component part of the bearing unit 50) fixed integrally to the stator yoke 13A formed as one body with a holder 16A formed in a tubular shape at a central portion of the stator yoke 13A, and the core 15 around which the coil 14 supplied with a driving current is wound is attached to an outer peripheral part of the bearing unit 50.

As has been described above, the motor 120 according to an embodiment of the present invention includes the above-described bearing unit 50, whereby the configuration thereof can be simplified and reduced in size, the assembly process thereof can be simplified, the leakage of the lubricating oil can be prevented, a high rotation performance can be maintained over a long time, and enhanced reliability can be attained.

Furthermore, in the motor 120 according to an embodiment of the present invention, the step of fastening the bearing unit 50 and the stator 12A to each other can be simplified, and the number of component parts can be reduced by forming the case member 35 of the bearing unit 50 as one body with the stator yoke 13A. In addition, when the stator 12A is molded from a synthetic resin and the female screw part 35a is formed simultaneously with the molding, the motor 120 can be manufactured inexpensively while simplifying the manufacturing process further.

Incidentally, in the motor according to an embodiment of the present invention, absorbing means 121 for absorbing a mist or the like generated by evaporation of the lubricating oil 121 may be provided, for example, on the inner peripheral surface of a tubular part 17a of the rotor yoke 17. Where the absorbing means 121 is provided, further, the bad influence of scattering of the lubricating oil 42 on other component parts can be obviated.

In addition, the bearing unit and the motor according to an embodiment of the present invention may be so configured that the bearing holder member in the bearing unit is formed as one body with the stator of the motor; for example, the bearing unit and the motor may be configured as shown in FIG. 13. Incidentally, the motor shown in FIG. 13 has a configuration in which the bearing holder member 114 of the bearing unit 110 shown in FIG. 11 is formed as one body with the stator of the motor shown in FIG. 1. In the following description, the same parts as those in the motor 1 shown in FIG. 1 and the bearing unit 110 shown in FIG. 11 will be denoted by the same symbols, and detailed descriptions of them will be omitted.

The motor 130 shown in FIG. 13 includes a rotor 11 and a stator 12B. The stator 12B includes a stator yoke 13B, the above-described bearing unit 110 according to an embodiment of the present invention, a coil 14, and a core 15 around which the coil 14 is wound. The bearing unit 110 has a configuration in which the above-mentioned bearing holder member 114 (a component part of the bearing unit 110) is formed as one body with a holder 16B formed in a tubular shape at a central portion of the stator yoke 13B. As shown in FIG. 13, the core 15 around which the coil 14 supplied with a driving current is wound is attached to an outer peripheral part of the bearing unit 110 integrally fixed to the stator yoke 13B.

As has been described above, the motor 130 according to an embodiment of the present invention includes the above-described bearing unit 110, whereby the configuration thereof can be simplified and reduced in size, and the assembly process thereof can be simplified. Further, it is possible to prevent the leakage of the lubricating oil, to maintain a high rotation performance for a long time, and to enhance the reliability.

Furthermore, in the motor 130 according to an embodiment of the present invention, the step of fastening the bearing unit 110 and the stator 12B to each other can be simplified, and the number of component parts can be reduced by forming the bearing holder member 114 of the bearing unit 110 as one body with the stator yoke 13B. In addition, where the stator 12B is molded from a synthetic resin and the male screw part 34a is formed simultaneously with the molding, the motor 130 can be manufactured inexpensively while simplifying the manufacturing process.

Incidentally, the bearing unit and the motor according to an embodiment of the present invention may have a configuration in which a case member or a bearing holder member in the bearing unit is integrally formed on the side of the rotor 11 of the motor.

The bearing unit according to an embodiment of the present invention can be used not only as a bearing for a cooling fan motor in a radiator and for a spindle motor in a disk drive but also as a bearing in various motors.

Furthermore, the bearing unit according to an embodiment of the present invention can not only be used for motors but also be used widely for mechanisms including a rotating shaft and mechanisms supporting a component part rotated relative to a shaft.

It should be understood by those skilled in the art that various modifications, combinations, sub-combinations and alterations may occur depending on design requirements and other factors insofar as they are within the scope of the appended claims or the equivalents thereof.

What is claimed is:

1. A bearing unit comprising:
a radial bearing for bearing a shaft in the circumferential direction of said shaft;
a first housing member provided on the outer periphery side and on one end side in the axial direction of said radial bearing and operative to retain said radial bearing; and
a second housing member provided on the outer periphery side of said first housing member and on the other end side in the axial direction of said radial bearing, wherein
said first and second housing members are united by a screw part provided on the outer periphery side of said first housing member and a screw part provided on the inner periphery side of said second housing member so as to sealingly contain said radial bearing, with a shaft passage hole provided on said one end side or said other end side in said axial direction so as to permit said shaft to pass therethrough, and
the inside of said united first and second housing members is filled with a viscous fluid.

2. The bearing unit as set forth in claim 1, wherein a seal member for sealing said viscous fluid is provided between said first housing member and said second housing member.

3. The bearing unit as set forth in claim 2, wherein said seal member is integrally provided with a thrust bearing for bearing one end in a thrust direction of said shaft.

4. The bearing unit as set forth in claim 1, wherein at least one of said first and second housing member is formed of a synthetic resin.

5. The bearing unit as set forth in claim 1, wherein a communicating passage is formed between said united first and second housing members and said radial bearing, said communicating passage making communication between one end side and the other end side in said thrust direction of said shaft protruding from said radial bearing.

6. The bearing unit as set forth in claim 1, wherein said first housing member is provide with an anti-slip mechanism used in fastening said first housing member with said second housing member.

7. The bearing unit as set forth in claim 1, wherein said second housing member is provided with an anti-slip mechanism used in fastening said second housing member with said first housing member.

8. The bearing unit as set forth in claim 1, wherein said radial bearing is an oil-impregnated sintered bearing.

9. The bearing unit as set forth in claim 1, wherein said radial bearing is a dynamic pressure fluid bearing.

10. A motor comprising a bearing unit bearing a rotor rotatably relative to a stator,
said bearing unit including:
a radial bearing for bearing a shaft in the circumferential direction of the shaft;
a first housing member provided on the outer periphery side and on one end side in the axial direction of said radial bearing and operative to retain said radial bearing; and
a second housing member provided on the outer periphery side of said first housing member and on the other end side in the axial direction of said radial bearing, wherein
said first and second housing members are united by a screw part provided on the outer periphery side of said first housing member and a screw part provided on the inner periphery side of said second housing member so as to sealingly contain said radial bearing, with a shaft passage hole provided on said one end side or said other end side in said axial direction so as to permit said shaft to pass therethrough, and
the inside of said united first and second housing members is filled with a viscous fluid.
